(19) United States
(12) Patent Application Publication
(10) Pub. No.: US 2023/0065642 A1
(43) Pub. Date: Mar. 2, 2023

(54) ELECTRIC PUMP WITH ISOLATED STATOR

(71) Applicant: Eaton Intelligent Power Limited, Dublin (IE)

(72) Inventor: Martin Augustine Clements, Loveland, OH (US)

(21) Appl. No.: 17/895,704

(22) Filed: Aug. 25, 2022

Related U.S. Application Data
(60) Provisional application No. 63/237,383, filed on Aug. 26, 2021.

(51) Int. Cl. F04D 29/58; F04D 17/16; F04D 25/06; F04D 29/02; F04D 29/051; F04D 29/057; F04D 29/08; F04D 29/44

(52) U.S. Cl. CPC F04D 29/5806; F04D 17/16; F04D 25/06; F04D 29/023; F04D 29/051; F04D 29/057; F04D 29/083; F04D 29/444; F04D 29/5826; B33Y 80/00

(57) ABSTRACT

The present disclosure relates to an electric pump including a housing defining an inlet and an outlet. The electric pump includes a rotor and stator within the housing. The rotor is liquid cooled by working fluid of the pump and the stator is positioned in a dry chamber that is sealed to prevent the working fluid from entering the dry chamber. A heat exchanger is used to cool the stator. An impeller driven by the rotor draws working fluid into the housing through the inlet. The working fluid passes through the heat exchanger to draw heat from the stator before reaching the impeller. The working fluid is discharged from the housing through the outlet by the impeller.

### CROSS REFERENCE TO RELATED APPLICATIONS

This application claims the benefit of provisional application Ser. No. 63/237,383, filed Aug. 26, 2021, which is incorporated herein by reference in its entirety.

### TECHNICAL FIELD

The present disclosure relates generally to pumps. More particularly, the present disclosure relates to electric pumps having components cooled by working fluid of the pumps.

### BACKGROUND

Electric pumps include a housing defining an inlet and an outlet. A rotor and a stator are mounted in the housing. The stator surrounds the rotor. The rotor includes a shaft coupled to an impeller for moving working fluid through the housing in a direction from the inlet to the outlet. The housing can be configured such that the working fluid contacts the rotor and the stator to provide cooling of the rotor and the stator.

### SUMMARY

The present disclosure relates to an electric pump including a housing defining an inlet and an outlet. The electric pump includes a rotor and stator within the housing. The rotor is liquid cooled by working fluid of the pump and the stator is positioned in a dry chamber that is sealed to prevent the working fluid from entering the dry chamber. A heat exchanger is used to cool the stator. An impeller driven by the rotor draws working fluid into the housing through the inlet. The working fluid passes through the heat exchanger to draw heat from the stator before reaching the impeller. At the impeller, the working fluid is pressurized and forced toward the outlet where the working fluid is discharged from the pump. In one example, an isolation sleeve surrounding the rotor is used to isolate the stator from the working fluid that cools (e.g., bathes) the rotor. In one example, the isolation chamber also prevents the working fluid from applying pressure to the stator. In one example, the impeller is a centrifugal impeller surrounded by a volute passage. In one example, the isolation tube is sealed relative to the housing by seals such as radial seals positioned adjacent to opposite ends of the isolation tube.

A variety of additional aspects will be set forth in the description that follows. The aspects can relate to individual features and to combinations of features. It is to be understood that both the forgoing general description and the following detailed description are exemplary and explanatory only and are not restrictive of the broad inventive concepts upon which the examples disclosed herein are based.

### BRIEF DESCRIPTION OF THE DRAWINGS

The accompanying drawings, which are incorporated in and constitute a part of the description, illustrate several aspects of the present disclosure. A brief description of the drawings is as follows:

FIG. 1 is a cross-sectional view of an electric pump in accordance with the principles of the present disclosure;

FIG. 2 depicts a centrifugal impeller and volute passage of the electric pump of FIG. 1; and

FIG. 3 is a cross-sectional view of a twin-impeller version of the electric pump of FIG. 1.

### DETAILED DESCRIPTION

Certain aspects of the present disclosure relate to electric pumps having rotor assemblies that are cooled by working fluid and stators that are isolated from the working fluid. In certain examples, it can be beneficial to isolate the stator from the working fluid to prevent the stator from being exposed to relatively high hydraulic pressures associated with the working fluid. For example, a pump adapted to convey a working fluid such as supercritical carbon dioxide often is rated to accommodate pump inlet pressures greater than or equal to 2000 pounds per inch (psi), or greater than or equal to 2250 psi or greater than or equal to 2500 psi. In certain applications and with certain types of stators, such relatively high pressures may cause damage to portions of the stators (e.g., windings of the stators) if the stators are exposed to such pressures.

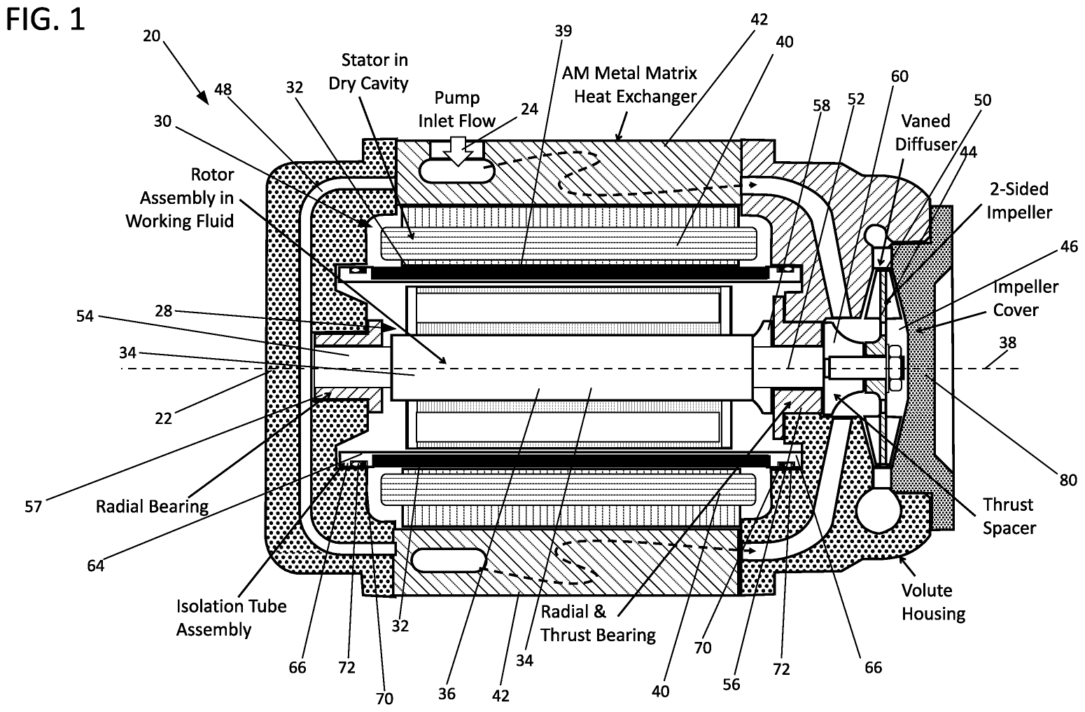

FIG. 1 depicts an electric pump 20 in accordance with the principles of the present disclosure. In certain examples, the electric pump 20 can be adapted to pump a working fluid having relatively low viscosity and relatively high inlet pressures. One example type material can include supercritical carbon dioxide. In certain examples, the electric pump 20 can be designed to accommodate inlet pressures greater than or equal to 2000 psi, or greater than or equal to 2250 psi or greater than or equal to 2500 psi.

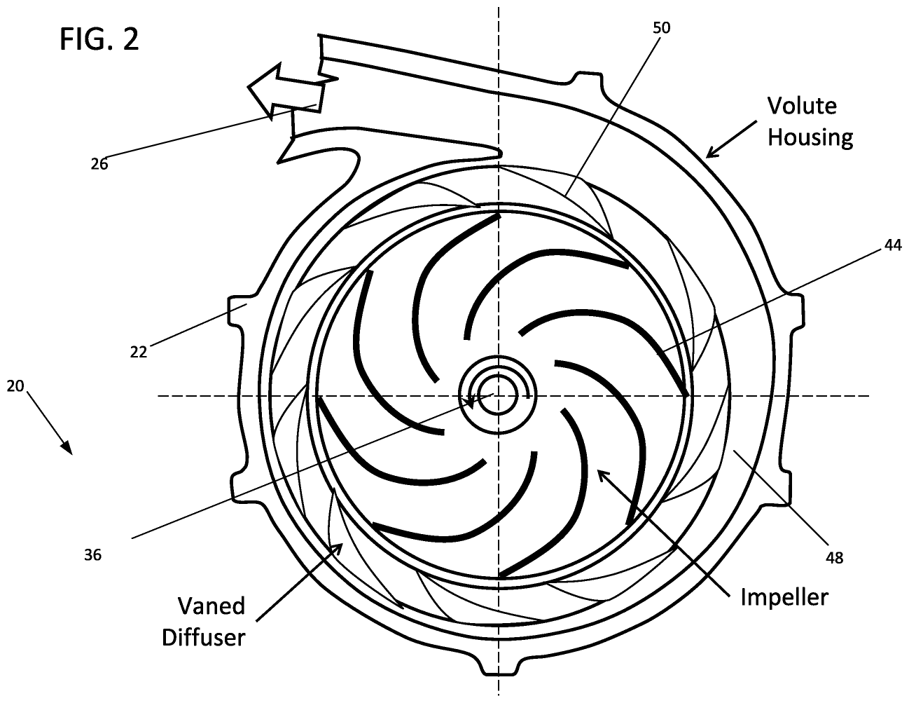

Referring to FIGS. 1 and 2, the electric pump 20 includes a housing 22 defining an inlet 24 and an outlet 26. A rotor chamber 28 and a stator chamber 30 are defined within the housing 22. The stator chamber 30 surrounds the rotor chamber 28 and is isolated from the rotor chamber 28 by an isolation sleeve 32. A rotor assembly 34 is positioned within the rotor chamber 28. The rotor assembly 34 includes a rotor shaft 36 that extends along a rotor axis 38. The rotor assembly 34 is rotatable about the rotor axis 38. A stator assembly 40 surrounds the rotor assembly 34. The stator assembly 40 is positioned within the stator chamber 30. The stator chamber 30 is isolated from the rotor chamber 28 such that working fluid present in the rotor chamber 28 is prevented from entering the stator chamber 30. Preferably, the stator chamber 30 is a dry chamber and is configured such that the working fluid being pumped through the electric pump is prevented from contacting or applying hydraulic pressure to the stator assembly 40.

It will be appreciated that the rotor assembly 34 and the stator assembly 40 are configured to function as an electric motor with the rotor assembly 34 being the rotational part of the electric motor and the stator assembly 40 being the non-rotational part of the electric motor. In certain examples, the stator assembly 40 generates magnetic fields which drive rotation of the rotor assembly 34. It will be appreciated that the rotor assembly 34 and/or the stator assembly 40 can include complements such as wire windings (e.g., copper wire windings), magnets or other components typically used in electric motors.

The electric pump 20 is preferably configured such that the working fluid is allowed to enter the rotor chamber 28 to bathe and cool the rotor assembly 34. As indicated above, the isolation sleeve 32 is configured to prevent the working fluid from entering the stator chamber 30. In one example, the isolation sleeve 32 is sealed relative to the housing 22 such that the housing and the isolation sleeve 32 cooperates to prevent working fluid from flowing from the rotor chamber 28 to the stator chamber 30.

Rather than being cooled by direct contact with the working fluid, the stator assembly 40 is preferably cooled by a heat exchanger 42 through which the working fluid flows. The heat exchanger 42 surrounds the stator assembly 40 and in certain examples contacts an outer diameter of the stator assembly 40. Working fluid flowing through the heat exchanger 42 draws heat from the stator assembly 40 to cool the stator assembly 40. In one example, the heat exchanger 42 has a metal construction and can be manufactured using an additive manufacturing process. By using an additive manufacturing process, an arrangement of fluid passages can be defined within the heat exchanger 42. The fluid passages are adapted to pass in close proximity to the stator assembly 40 to promote the effective transfer of heat from the stator assembly 40 to the working fluid flowing through the heat exchanger 42.

The electric pump 20 also includes an impeller 44 coupled to the rotor shaft 36 for drawing the working fluid from the inlet 24 through the heat exchanger 42 to an impeller chamber 46 in which the impeller 44 is mounted. The working fluid is pressurized within the impeller chamber 46 and directed toward the outlet 26 of the housing 22 such that the working fluid is discharged from the housing 22 through the outlet 26. In one example, the impeller 44 is a centrifugal impeller and a volute passage 48 is defined by the housing 22 around the impeller 44 (see FIG. 2). Rotation of the impeller 44 directs the working fluid outwardly from the impeller chamber 46 into the volute passage 48. The housing 22 can include an impeller cover 80 that attaches to a main body of the housing 22 and defines a portion of the impeller chamber 46. Flow of the working fluid proceeds around the volute passage 48 and is discharged from the pump housing 22 through the outlet 26 (see FIG. 2). Diffuser vanes 50 can be provided between the impeller 44 and the volute passage 48 for assisting in providing more uniform flow about the circumference of the impeller 44 into the volute passage 48. In one example, the impeller 44 is co-axially aligned with the rotor shaft 36 and rotates in unison with the rotor shaft 46 as the rotor assembly 34 rotates about the rotor axis 38. Thus, the rotor assembly 34 drives rotation of the impeller 44 about the rotor axis 38.

The rotor shaft 36 has a first end 52 and a second end 54 opposite to the first end. The first end 52 couples to the impeller 44 and is supported by a first bearing 56 coupled to the housing 22 that provide both radial and axial bearing functionality. In one example, the first bearing 56 is attached to the housing 22 so as to be axially fixed along the rotor axis 38. In one example, the first bearing 56 can be configured to support the rotor shaft 36 for rotation about the rotor axis 38 and in certain examples can be configured as a hydrodynamic bearing such that the rotor shaft 36 is fluidly supported within the bearing 56. The bearing 56 can be positioned between first and second spacers 58, 60 fixed on the rotor shaft 36. In this way, axial contact between the spacers 58, 60 and the bearing 56 limits or restricts axial movement of the rotor shaft 36 relative to the housing 22 along the rotor axis 38. The second end 54 of the rotor shaft 36 is supported by a second bearing 57 which can provide radial bearing functionality can include a hydrodynamic bearing. In one example, the second bearing 57 does not function as an axial bearing and the rotor shaft 36 can move axially relative to the radial bearing 57 to accommodate thermal expansion and contraction of the rotor shaft 36. In one example, the housing 22 can be configured such that pressure of the working fluid is allowed to act on opposite ends of the rotor shaft 36 to provide axial force balancing. In certain example, passages can be provided within the housing 22 to ensure the working fluid can flow to the regions adjacent the opposite axial ends of the rotor shaft 36.

In certain examples, the isolation sleeve 32 can have a composite construction. For example, the isolation sleeve 32 can include different portions having different material constructions. In one example, the isolation sleeve 32 can include an inner sleeve portion 64 having a metal construction (e.g., steel or aluminum) and an outer sleeve portion 66 mounted within a recess defined at an exterior of the inner sleeve portion 64. In one example, the outer sleeve portion 66 can include a construction that includes carbon fibers. The isolation sleeve 32 is preferably sealed relative to the housing 22. For example, sealing arrangements 39 can be provided adjacent opposite ends of the isolation sleeve 32. In one example, each of the sealing arrangements 39 can include a seal 70 (e.g., a gasket such as an o-ring or other type of seal) and a back-up ring 72 for preventing deformation/extrusion of the seal under pressure. In one example, the seals 70 are radial seals mounted within circumferential grooves defined about the circumference of the isolation sleeve 32 adjacent the ends of the isolation sleeve 32. The seals 70 preferably seal against corresponding sealing surfaces defined by the housing 22.

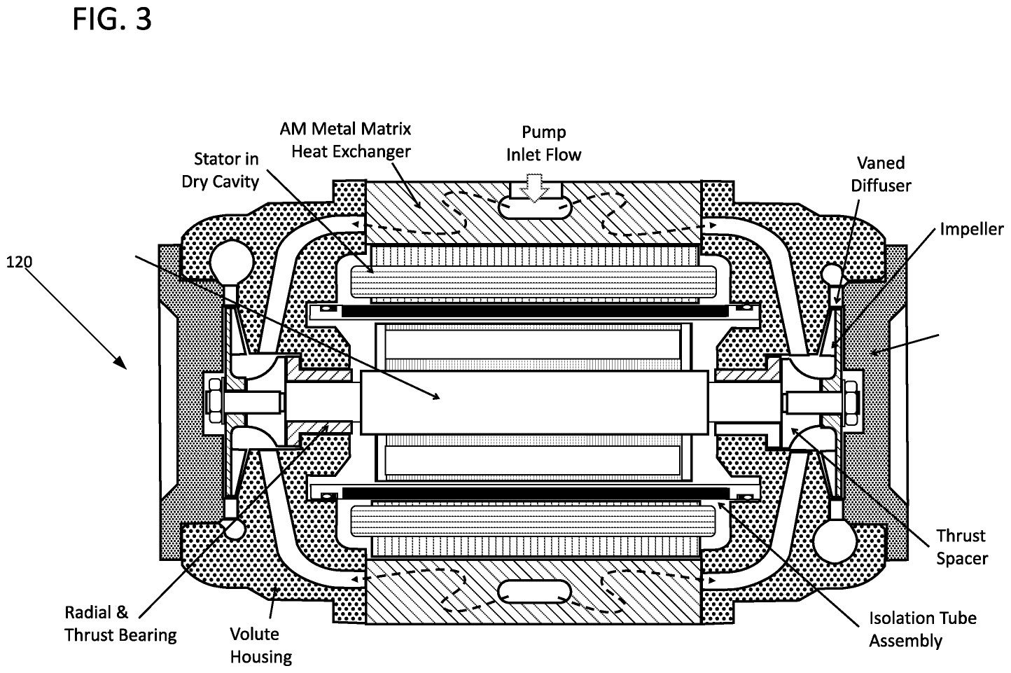

FIG. 3 depicts an alternative electric pump 120 in accordance with the principles of the present disclosure. The electric pump 120 is similar to the electric pump 20, except the electric pump 120 has a twin-impeller design as compared to a single impeller design.

1. An electric pump for pumping a working fluid, the pump comprising:
a housing defining an inlet and an outlet;
a rotor chamber and a stator chamber within the housing, the stator chamber surrounding the rotor chamber and being isolated from the rotor chamber by an isolation sleeve;
a rotor assembly positioned within the rotor chamber, the rotor assembly including a rotor shaft that extends along a rotor axis, the rotor assembly being rotatable about the rotor axis;
the electric pump being configured such that working fluid is allowed to enter the rotor chamber to bathe and cool the rotor assembly, the isolation sleeve being configured to prevent the working fluid from entering the stator chamber from the rotor chamber, the stator chamber being a dry chamber;
a stator assembly surrounding the rotor assembly, the stator assembly being positioned within the stator chamber;
a heat exchanger positioned around the stator assembly for drawing heat from the stator assembly; and
an impeller coupled to the rotor shaft for drawing the working fluid from the inlet through the heat exchanger and for discharging the working fluid out the outlet.

2. The electric pump of claim 1, wherein the impeller rotates with the shaft about the rotor axis, wherein the impeller is centrifugal impeller positioned within an impeller chamber of the housing, and wherein the housing defines a volute passage that extends about the impeller for directing the working fluid from the impeller toward the outlet.

3. The electric pump of claim 2, further comprising a diffuser including vanes positioned between the impeller and the volute passage.

4. The electric pump of claim 1, wherein the electric pump is rated to accommodate inlet pressures greater than 2000 pounds per square inch (psi), or greater than 2250 psi or equal to 2500 psi.

5. The electric pump of claim 1, wherein the working fluid is supercritical carbon dioxide.

6. The electric pump of claim 1, wherein the heat exchanger has an additive manufactured metal construction.

7. The electric pump of claim 1, wherein the rotor shaft has a first end adjacent the impeller supported by a first bearing and an opposite second end supported by a second bearing, the first bearing providing radial and axial bearing functionality and the second bearing providing only radial bearing functionality.

8. The electric pump of claim 7, wherein the first bearing is coupled to the housing and is captured between spacers coupled to the rotor shaft, and wherein the second bearing is configured to accommodate length changes of the rotor shaft caused by thermal expansion and contraction.

9. The electric pump of claim 1, wherein the housing is configured such that pressure of the working fluid can act on opposite ends of the rotor shaft to provide axial force balancing.

10. The electric pump of claim 2, wherein the impeller is a two-sided impeller.

11. The electric pump of claim 7, wherein the first and second bearings include hydrodynamic fluid bearings that are radially force balanced.

12. The electric pump of claim 1, wherein the isolation sleeve has a composite construction.

13. The electric pump of claim 12, wherein the isolation sleeve includes an inner sleeve portion having a metal construction and an outer sleeve portion mounted on the inner sleeve portion having a carbon fiber construction.

14. The electric pump of claim 1, wherein the isolation sleeve has first and second ends, and wherein seals are provided adjacent the first and second ends for sealing between the isolation sleeve and the housing.

15. The electric pump of claim 1, wherein the seals include radial seals supported by back-up rings.
